(19) United States
(12) Patent Application Publication
(10) Pub. No.: US 2007/0152109 A1
(43) Pub. Date: Jul. 5, 2007

(54) Attachment apparatus and methods for use thereof

(75) Inventors: John Wade Kroening, New Berlin, WI (US); Stephanie Allison Swenor, Mukwonago, WI (US); Sabih Qamaruz Zaman, Elm Grove, WI (US)

Correspondence Address: RAMIREZ & SMITH, PO BOX 341179, AUSTIN, TX, 78734, US

(73) Assignee: General Electric Company, Schenectady, NY (US)

(21) Appl. No.: 11/320,924

(22) Filed: Dec. 29, 2005

(51) Int. Cl. F16L 3/08

(52) U.S. Cl. 248/65

(57) ABSTRACT

An attachment device, which can be used in conjunction with an x-ray system, is provided including a clasp having a bracket configured to support an object in the clasp and a flap configured to retain the object in the clasp, the flap being further configured to automatically return the clasp to a closed position from both an inward-opening and an outward-opening position, and a mount attached to the clasp for affixing the clasp to a surface. A method of attaching an object to a surface is also provided including pushing the object into a clasp of an attachment device mounted to the surface, the clasp having a bracket configured to support the object in the clasp and a flap configured to retain the object in the clasp, the flap being further configured to automatically return the clasp to a closed position from an inward-opening position resulting from the object being pushed into the clasp.

### FIELD OF THE INVENTION

This invention relates generally to attachment solutions, and more particularly to attachment devices and techniques for use thereof.

### BACKGROUND OF THE INVENTION

Many portable x-ray systems are used in conjunction with an x-ray detector that is attached to the system by a cable. The cable, which is typically at least five meters in length, transfers power and data from the system to the detector.

Since the x-ray systems are typically used in patient care applications, it is important that the cable is kept as clean as possible, so as to prevent patient-to-patient contamination. One way to help ensure that the cable remains clean is to prevent the cable from coming in contact with unclean surfaces, such as the ground. Minimizing any amount of slack in the cable, during use or storage of the system, helps prevent any part of the cable from hitting the ground.

Some conventional systems employ cable attachment mechanisms that include open, opposite facing hooks, fixed at a distance from one another, around which a user wraps the cable. Such mechanisms are, however, cumbersome. The user has to unwind the cable from the hooks to release a section of the cable for use. In doing so, the user has to estimate how much cable she is going to need. If the user underestimates the amount of cable needed, the user will have to return to the mechanism to unwind more cable, which is time consuming. If the user overestimates the amount of cable needed, then any extra slack present can lead to a portion of the cable hitting the floor, resulting in possible contamination.

For the reasons stated above, and for other reasons stated below which will become apparent to those skilled in the art upon reading and understanding the present specification, there is a need in the art for more effective and efficient cable attachment techniques.

### BRIEF DESCRIPTION OF THE INVENTION

An attachment device is provided. The attachment device includes a clasp having a bracket configured to support an object in the clasp and a flap configured to retain the object in the clasp, the flap being further configured to automatically return the clasp to a closed position from both an inward-opening and an outward-opening position, and a mount attached to the clasp for affixing the clasp to a surface.

A method of attaching an object to a surface is also provided. The method includes pushing the object into a clasp of an attachment device mounted to the surface, the clasp having a bracket configured to support the object in the clasp and a flap configured to retain the object in the clasp, the flap being further configured to automatically return the clasp to a closed position from an inward-opening position resulting from the object being pushed into the clasp.

An x-ray system is further provided. The system includes a host computer and an x-ray detector connected to the host computer by a cable, the cable being affixed to a surface of the system by an attachment device. The attachment device includes a clasp having a bracket configured to support the cable in the clasp and a flap configured to retain the cable in the clasp, the flap being further configured to automatically return the clasp to a closed position from both an inward-opening position and an outward-opening position, and a mount attached to the clasp for affixing the clasp to the surface of the system.

Apparatus and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a diagram of an illustrative attachment device;

FIG. 2 is a diagram of an illustrative attachment device being employed in an x-ray system; and

FIG. 3 is a diagram of an illustrative methodology for using an attachment device to retain and release a cable.

### DETAILED DESCRIPTION OF THE INVENTION

Accordingly, an attachment device 100 provides an efficient and effective way to manage the cables found on medical x-ray equipment. The unique properties of attachment device 100 allow a user to access only the length of cable needed, easing use of the equipment and preserving the cleanliness of the cable.

The detailed description is divided into three sections. In the first section, attachment apparatus are described. In the second section, methods of using the apparatus are described. Finally, in the third section, a conclusion of the detailed description is provided.

### APPARATUS EMBODIMENTS

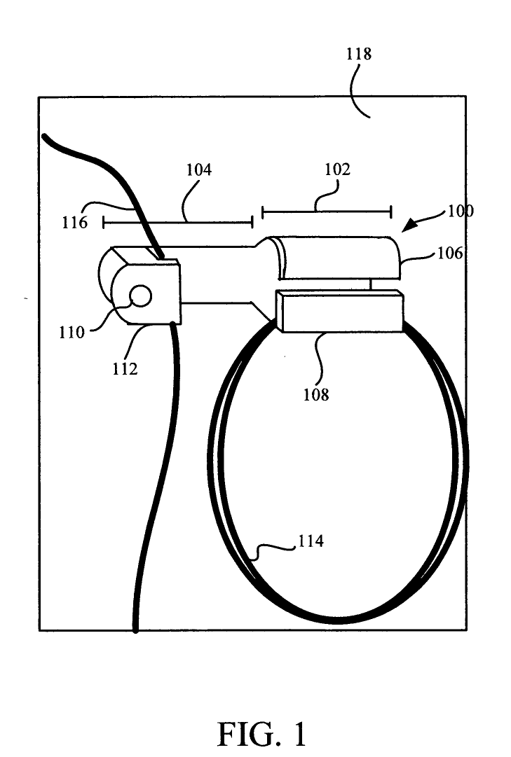

Apparatus that solve the above-stated needs and thus provide improved attachment solutions are now described. FIG. 1 is a diagram of illustrative attachment device 100. Attachment device 100 includes clasp 102 and mount 104. Clasp 102 includes flap 106 and bracket 108. Mount 104 includes mounting point 110 and hook 112, e.g., a cable retention hook, as described below.

Attachment device 100 affixes objects, such as cable 114, to surface 118. Surface 118 can be a vertical surface (as shown in FIG. 1), a horizontal surface, or a surface having a slope of any degree therebetween. Attachment device 100 can be used to affix any object having a rounded or cylindrical shape, including, but not limited to, cables, cords, hoses, tubing, pipes, ropes, wires and conduit.

Clasp 102 retains and supports objects in attachment device 100. Specifically, flap 106 retains objects in clasp 102, and bracket 108 supports objects in clasp 102.

Clasp 102 has a “self-closing” property. Namely, after clasp 102 has been opened, either by an object being inserted into clasp 102 (an inward-open position) or by an object being removed from clasp 102 (an outward-open position), clasp 102 automatically returns to a closed position. The opening and closing of clasp 102 is further described in detail below.

The self-closing properties of clasp 102 are attributable to flap 106 being configured to move in multiple directions relative to bracket 108. For example, according to one illustrative embodiment, flap 106 is composed of a flexible material. The flexible material allows flap 106 to bend both inward (i.e., in towards surface 118) and outward (i.e., away from surface 118) when a force is exerted on flap 106.

A force is exerted on flap 106 when cable 114 is inserted into clasp 102. A force is also exerted on flap 106 when cable 114 is removed from clasp 102. The flexible material has a resilient flexibility that permits flap 106 to return to its original shape after being distorted, i.e., as a result of bending. Thus, when there is no longer a force being exerted on flap 106, flap 106 returns to its original position, returning clasp 102 to a closed position.

To have flexibility, flap 106 can be formed from a flexible soft durometer plastic material. Suitable flexible materials for forming flap 106 include, but are not limited to, elastomeric materials, including plastic materials such as an acrylonitrile butadiene styrene (ABS) material and an ABS/polycarbonate (PC) (ABS/PC) alloy material.

It is important for proper functioning of attachment device 100 that flap 106 is flexible and bracket 108 is not flexible, i.e., bracket 108 is rigid. That way, flap 106 can move relative to bracket 108, as described above. Thus, according to one illustrative embodiment, flap 106 is made of a flexible material and the other components of attachment device 100, including bracket 108, are made of a different, non-flexible material.

Alternatively, in another embodiment, attachment device 100 is made from a single material, e.g., an ABS/PC injection molded plastic, for ease of manufacture. In this alternative embodiment, the properties of attachment device 100 are selected such that flap 106 is flexible and the other components of attachment device 100, including bracket 108, are not flexible. Flexibility of flap 106 can be achieved and controlled by varying the thickness of the material used in forming flap 106. For example, flap 106 can be made to be thinner than the other components of attachment device 100. As such flap 106 will be flexible and the other components of attachment device 100 will be rigid.

It is not, however, necessary for flap 106 to be composed of a flexible material. By way of example only, flap 106 can be composed of a non-flexible material and be attached to clasp 102 by a spring mechanism. This configuration would permit the same movement of flap 106, i.e., in multiple directions relative to bracket 108, as when flap 106 is composed of a flexible material.

Mount 104 affixes attachment device 100 to surface 118, e.g., at mounting point 110. Attachment device 100 can be affixed to surface 118 using any suitable attachment techniques. For example, attachment device 100 can be affixed to surface 118 using a fastener. Suitable fasteners include, but are not limited to, screws, rivets, posts and clamps. Attachment device 100 can also be affixed to surface 118 using an adhesive.

Mount 104 further includes hook 112. Hook 112 is an optional component. Hook 112 is characteristic of a commonly used cable retention hook found on electrical equipment. The use of cable retention hooks is well known to those of skill in the art and is not described in further detail herein. Hook 112 is used to capture cable 116.

An ideal location for placement of attachment device 100 on an equipment surface is where a cable retention hook already exists. To accomplish this, the cable retention hook is removed and the existing mounting point, i.e., of the cable retention hook, is used as the mounting point for attachment device 100. Hook 112 of attachment device 100 then functions as a replacement for the cable retention hook that was removed. Alternatively, if hook 112 is not present on attachment device 100, then the cable retention hook that was removed can be relocated to the outer surface of attachment device 100 at the same mounting point.

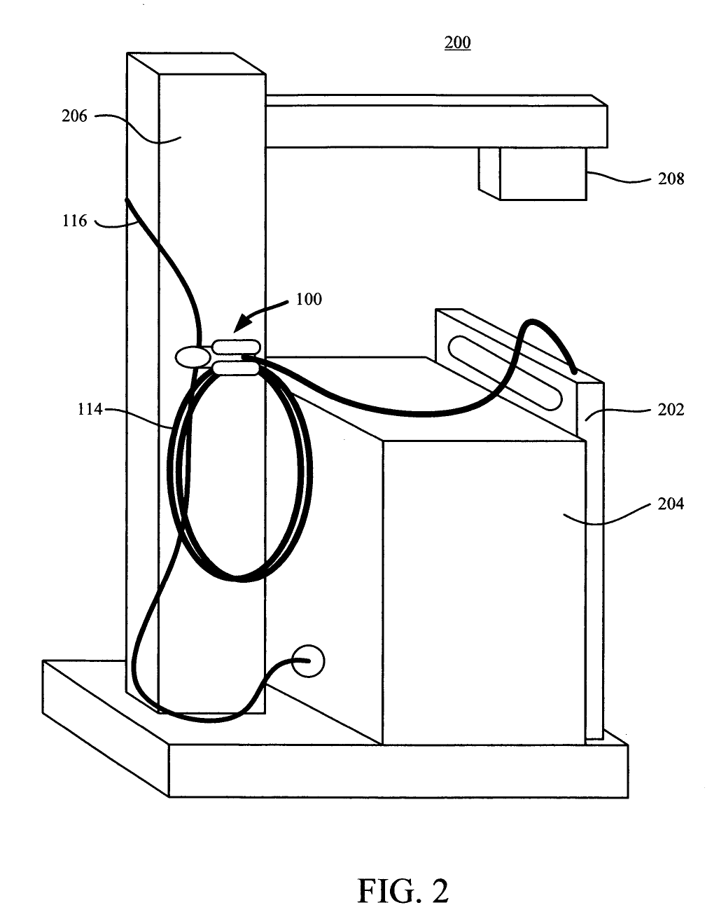

FIG. 2 is a diagram of attachment device 100 being employed in x-ray system 200. X-ray system 200 includes portable x-ray detector 202, host computer 204, post 206 and x-ray generator 208, e.g., an x-ray tube. Portable x-ray detector 202 is shown attached to, i.e., “docked” at, host computer 204. During normal operation of x-ray system 200, portable x-ray detector 202 is repeatedly attached to, and detached from, host computer 204. The use of a portable x-ray detector is known to those of skill in the art and is not described further herein.

Portable x-ray detector 202 is linked to host computer 204 by cable 114. Cable 114 transfers power and data from host computer 204 to portable x-ray detector 202.

As shown in FIG. 2, when portable x-ray detector 202 is docked at host computer 204, an excess length of cable 114 is looped and affixed to post 206 by attachment device 100. Attachment device 100 is positioned at a height on post 206 such that the loops of cable 114 do not make contact with the ground.

Attachment device 100 also affixes cable 116 to post 206. Prior to attachment device 100 being mounted on post 206, a cable retention hook on post 206 is removed. The mounting point of the cable retention hook is then used to mount attachment device 100, as described above. Attachment device 100 has a cable retention hook to replace the cable retention hook that is removed.

During operation of x-ray system 200, portable x-ray detector 202 is detached from host computer 204 and used in the capturing of x-ray images. At this point, at least a portion of the length of cable 114 retained by attachment device 100 will have to be released.

Because of the self-closing properties of clasp 102 associated with attachment device 100, a user of x-ray system 200 simply detaches portable x-ray detector 202 from host computer 204 and moves portable x-ray detector 202 to the imaging site. Any additional length of cable 114 needed to move portable x-ray detector 202 is automatically released from attachment device 100 when the user pulls on cable 114. Specifically, flap 106 of clasp 102, as described above, is composed of a flexible material. The flexible material permits flap 106 to bend outward in response to the force associated with the user pulling on cable 114.

As shown in FIG. 2, multiple loops of cable 114 can be retained by attachment device 100. When the user pulls on cable 114, the loop closest in the length of cable 114 to portable x-ray detector 202 will directly experience the pulling force. The movement of flap 106 will allow the length of cable 114 associated with that particular loop to be released from clasp 102. After that particular loop is released from clasp 102, flap 106 will return to its original position, closing clasp 102 and retaining the remaining length of cable 114.

Releasing the length of cable 114 in increments minimizes the presence of excess length, thereby reducing the likelihood that a portion of cable 114 will come in contact with an unclean surface, such as the ground. Releasing the length of cable 114 in increments also eliminates the need for the user to estimate how much of cable 114 will be needed for an application.

Once the user has finished with portable x-ray detector 202 and wishes to again attach portable x-ray detector 202 to host computer 204, the user simply loops the excess length of cable 114 and pushes each loop into clasp 102. Flap 106 of clasp 102 bends inward in response to the force associated with the user pushing cable 114 into clasp 102.

Further, during operation of x-ray system 200, post 206 is rotated to allow for the positioning of x-ray generator 208 over a subject, e.g., a patient. If portable x-ray detector 202 is attached to host computer 204, then any amount of additional cable 114 needed to accommodate for the rotation of post 206 can be automatically released from attachment device 100. Specifically, cable 114 is affixed to post 206 by attachment device 100. When post 206 rotates, any tension in cable 114 caused by the rotation can result in lengths of cable 114 being pulled from attachment device 100, as described above.

### METHOD EMBODIMENTS

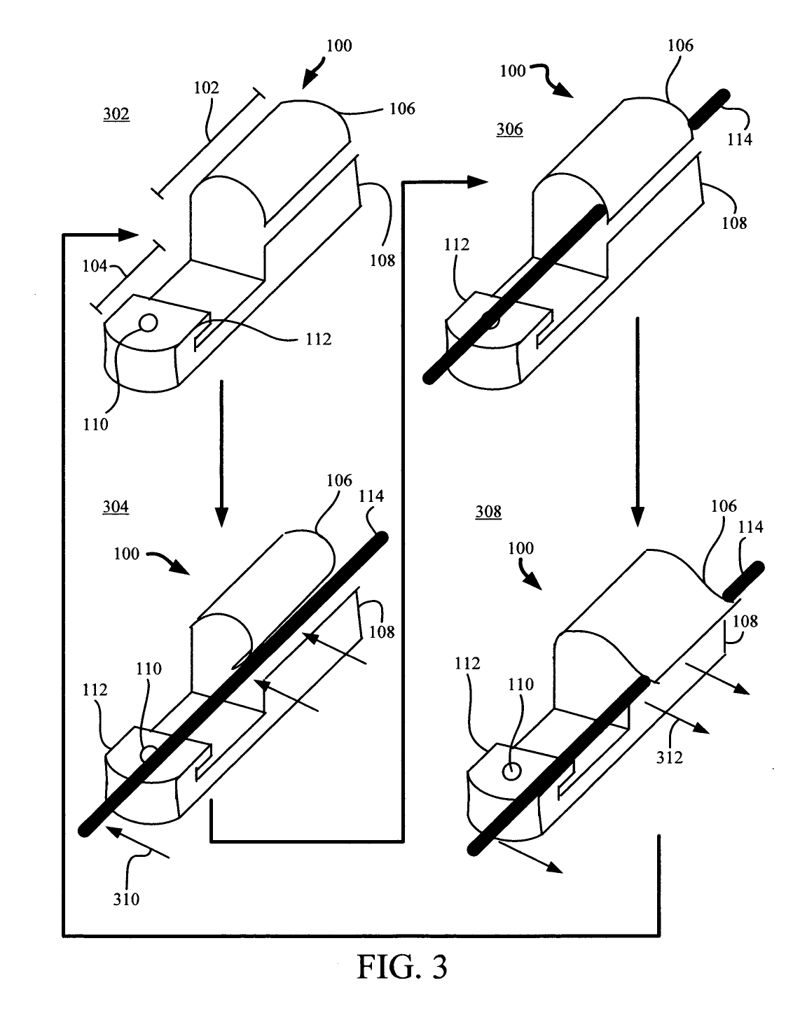

FIG. 3 is a diagram of an illustrative methodology for using attachment device 100 to retain and release a cable. In step 302, clasp 102 of attachment device 100 is in a closed position. Specifically, flap 106 is aligned with bracket 108.

In step 304, cable 114 is inserted into clasp 102. The force of cable 114 being pushed into clasp 102, as indicated by arrows 310, causes flap 106 to bend. Flap 106 bends to permit cable 114 to pass into clasp 102. Clasp 102 having flap 106 bending therein is in an inward-opening position.

In step 306, once cable 114 has fully passed into clasp 102, cable 114 is no longer in contact with flap 106. Without any force being exerted on flap 106 by cable 114, flap 106 returns to its original shape and position. Clasp 102 is thus returned to a closed position, retaining and supporting cable 114.

In step 308, cable 114 is removed from clasp 102. The force of cable 114 being pulled from clasp 102, as indicated by arrows 312, again causes flap 106 to bend. In this case, flap 106 bends outward to permit cable 114 to pass out of clasp 102. Clasp 102 having flap 106 bending out thereof is in an outward-opening position.

### Conclusion

Attachment apparatus and methods for use thereof have been described. Although specific embodiments are illustrated and described herein, any arrangement which is calculated to achieve the same purpose may be substituted for the specific embodiments shown. This application is intended to cover any adaptations or variations.

In particular, the names of the apparatus and methods are not intended to limit embodiments. Furthermore, additional methods and apparatus can be added to the components, functions can be rearranged among the components, and new components to correspond to future enhancements and physical devices used in embodiments can be introduced without departing from the scope of embodiments.

We claim:

1. An attachment device comprising:
a clasp having a bracket configured to support an object in the clasp and a flap configured to retain the object in the clasp, the flap being further configured to automatically return the clasp to a closed position from both an inward-opening and an outward-opening position; and
a mount attached to the clasp for affixing the clasp to a surface.

2. The device of claim 1, wherein the object is one or more of a cable, a cord, a hose, a tube, a pipe, a rope and a conduit.

3. The device of claim 1, wherein the flap comprises a flexible material.

4. The device of claim 3, wherein the flexible material comprises one or more of an elastomeric material, a plastic material, an acrylonitrile butadiene styrene material and an acrylonitrile butadiene styrene/polycarbonate alloy material.

5. The device of claim 1, further comprising a cable retention hook.

6. The device of claim 1, wherein the surface is a vertical surface, a horizontal surface, or a surface having a slope of any degree therebetween.

7. A method of attaching an object to a surface, the method comprising the step of:
pushing the object into a clasp of an attachment device mounted to the surface, the clasp having a bracket configured to support the object in the clasp and a flap configured to retain the object in the clasp, the flap being further configured to automatically return the clasp to a closed position from an inward-opening position resulting from the object being pushed into the clasp.

8. The method of claim 7, wherein the object is one or more of a cable, a cord, a hose, a tube, a pipe, a rope and a conduit.

9. The method of claim 7, wherein the flap comprises a flexible material.

10. The method of claim 9, wherein the flexible material comprises one or more of an elastomeric material, a plastic material, an acrylonitrile butadiene styrene material and an acrylonitrile butadiene styrene/polycarbonate alloy material.

11. The method of claim 7, wherein the surface comprises a surface of an x-ray system.

12. The method of claim 7, wherein the object comprises a cable in an x-ray system.

13. An x-ray system comprising:
a host computer;
an x-ray detector connected to the host computer by a cable, the cable being affixed to a surface of the system by an attachment device comprising:
a clasp having a bracket configured to support the cable in the clasp and a flap configured to retain the cable in the clasp, the flap being further configured to automatically return the clasp to a closed position from both an inward-opening position and an outward-opening position; and
a mount attached to the clasp for affixing the clasp to the surface of the system.

14. The system of claim 13, wherein the flap comprises a flexible material.

15. The system of claim 14, wherein the flexible material comprises one or more of an elastomeric material, a plastic material, an acrylonitrile butadiene styrene material and an acrylonitrile butadiene styrene/polycarbonate alloy material.

16. The system of claim 13, wherein the attachment device further comprises a cable retention hook.

17. The system of claim 13, further comprising an x-ray generator supported by a post, and wherein the attachment device is affixed to the post.

18. The system of claim 13, wherein the cable comprises a plurality of loops affixed to the surface by the attachment device.
